(19) United States
(12) Patent Application Publication
(10) Pub. No.: US 2009/0249532 A1
(43) Pub. Date: Oct. 8, 2009

(54) VEHICLE URINAL

(76) Inventors: Kenneth W. Smith, Homer, LA (US); Sue C. Smith, Homer, LA (US)

Correspondence Address: WOOD AND EISENBERG, PLLC, 3975 University Drive, SUITE 330, Fairfax, VA, 22030, US

(21) Appl. No.: 12/420,041

(22) Filed: Apr. 7, 2009

Related U.S. Application Data
(60) Provisional application No. 61/043,393, filed on Apr. 8, 2008.

(51) Int. Cl. B60R 15/00

(52) U.S. Cl. 4/114.1

(57) ABSTRACT

A waste liquid handling system especially suited for installation in the cab of a truck cabin. The system includes a removable urine collection cup, a waste holding tank, and a wash water reservoir having a battery powered pump. These three principal components may be contained within a single cabinet and may be individually removable therefrom. The cabinet may have a collection cup compartment from which the collection cup may emptied by engaging a drain valve. The collection cup may be washed by installing a removable cap which may be connected to the wash water reservoir. The system may include a vent fan and a cabinet light. A bed may be located in the cabinet above the holding tank and the wash water reservoir. Hoses used in the system may utilize quick connect fittings.

### CROSS-REFERENCE TO RELATED APPLICATIONS

This application claims priority to Application No. 61/043,393, filed Apr. 8, 2008, which is incorporated herein by reference in its entirety.

### STATEMENT REGARDING FEDERALLY SPONSORED RESERARCH OR DEVELOPMENT

Not applicable.

### BACKGROUND OF THE INVENTION

1. Field of the Invention

The present invention relates to a urinal for a wheeled vehicle, and more particularly to a urinal which is self-contained and readily installed in a pre-existing vehicle.

2. Background of the Invention

The need for toilet facilities has long interfered with long distance truck driving. The needs of nature cannot be predicted. When the need to urinate arises, truck drivers are obliged to seek the nearest toilet facilities. This is very disruptive to efficient travel as facilities located immediately off highways are few and far between. Most often, a truck driver must leave the highway to find suitable facilities.

Onboard facilities have been provided or proposed. However, such facilities frequently amount to little more than storage facilities which are not well equipped to cope with functions such as disposing waste efficiently, suppressing odors, and washing the facility and its environs.

There exists a need for a waste storage system which addresses the needs of transfer of waste, suppressing odors, and providing the ability to wash the facility and its environs.

There exists the further problem that tractor cabs are not readily adapted to receive and host waste storage systems. An aftermarket storage system must be readily received within a tractor cab and could be overly cumbersome or wasteful of cabin space, which is at a premium in most tractors.

Therefore, there is also a need for waste storage systems which may be installed easily and which occupy minimal space and intrude minimally on tractor cabs.

### SUMMARY OF THE INVENTION

The present invention sets forth a waste handling system which is well adapted to being placed in the cab of a tractor, which provides powered liquid transfer, both of waste and of clean wash water, and which has obstructions to splatter and odor emanation. The system includes three principal functional components. These include a urine collection cup which is utilized to collect urine and is closed and stowed at other times. The collection cup is emptied into a holding tank, using automatically self-closing quick connectors. The holding tank is the second major component. A wash water reservoir, the third major component, is connected to a battery powered pump for washing purposes. These three principal components may be contained within a single cabinet.

Each of the three principal components may be individually removable from the cabinet. The collection cup is removed and placed in a suitable location and oriented to collect urine during urination, then returned to a stowed location after emptying. The holding tank is readily removable to dispose of collected liquid wastes. The wash water reservoir is removable so that objects other than the novel waste handling system can be sprayed with pressurized water. Also, it becomes practical to refill the wash water reservoir when the latter is removed from the cabinet and thus becomes fully accessible.

According to one aspect of the invention, liquid conduits such as transfer hoses are provided with quick connectors for ready removal and assembly.

According to another aspect of the invention, a drain valve which normally closes the collection cup at the bottom thereof opens responsive to the collection cup being installed to a drain conduit. This is accomplished by a mechanical interlocking arrangement incorporating a valve which opens responsively to connection of the drain conduit, which is fitted with a mating connector.

### BRIEF DESCRIPTION OF THE DRAWINGS

Various features and attendant advantages of the present invention will become more fully appreciated as the same becomes better understood when considered in conjunction with the accompanying drawings, in which like reference characters designate the same or similar parts throughout the several views, and wherein:

FIG. 1 is a side elevational view of a waste liquid handling system according to at least one aspect of the invention.

FIG. 2 is a side elevational view of a waste liquid handling system according to at least one second aspect of the invention.

FIG. 3 is a partly exploded side elevational detail view of the upper left of FIG. 2, showing a removable collection cup in an emptying location.

FIG. 4 is a side elevational detail view of the upper left of FIG. 2, showing the removable collection cup in a stowed location.

FIGS. 5a and 5b show a table of reference numerals.

### DETAILED DESCRIPTION OF THE INVENTION

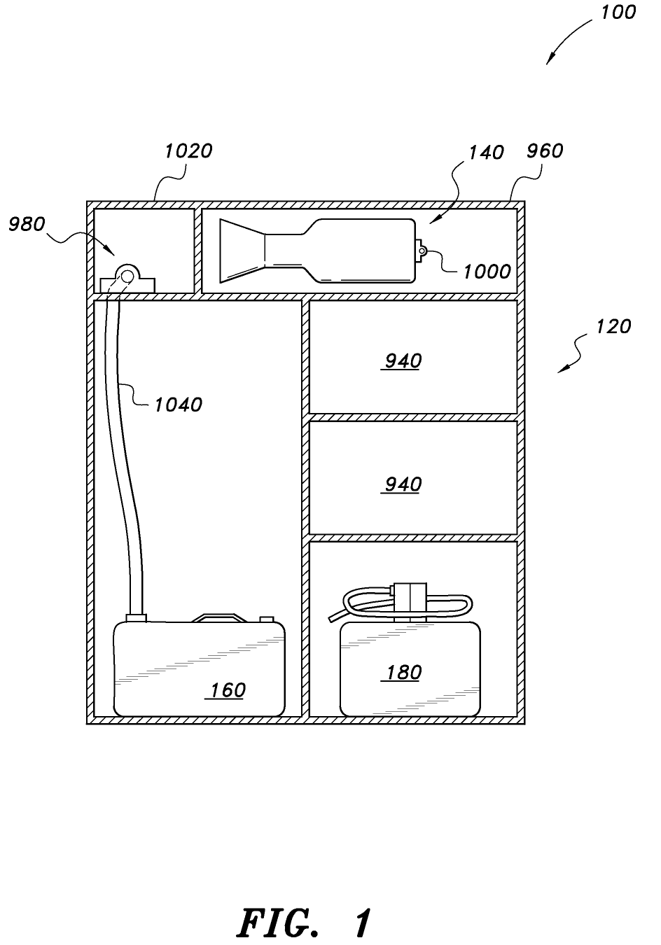

FIG. 1 shows a waste liquid handling system 100 especially adapted for retrofit installation within a transportation vehicle (not shown). The waste liquid handling system 100 may include a cabinet 120 for enclosing or supporting other components. These components include a mobile or portable collection cup 140 for collecting liquid wastes such as urine and unfinished beverages, a holding tank 160 for receiving liquid wastes from the collection cup 140, and a wash water tank 180 for rinsing or washing components of the waste liquid handling system 100 and other articles (none shown).

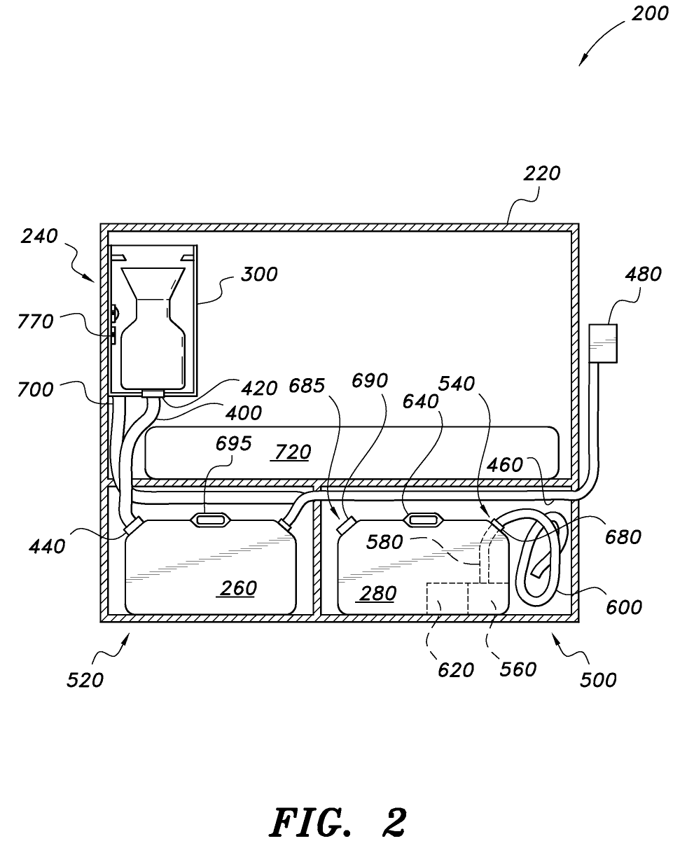

In another implementation of the invention, shown in FIG. 2, a waste liquid handling system 200 may be generally the functional equivalent of the waste liquid handling system 100, and may have a cabinet 220 which is larger than the cabinet 120. The waste liquid handling system 200 may include a mobile or portable collection cup 240, a holding tank 260, and a wash water tank 280. The collection cup 240, a holding tank 260, and a wash water tank 280 may be the structural and functional equivalents of their similarly named counterparts of FIG. 1.

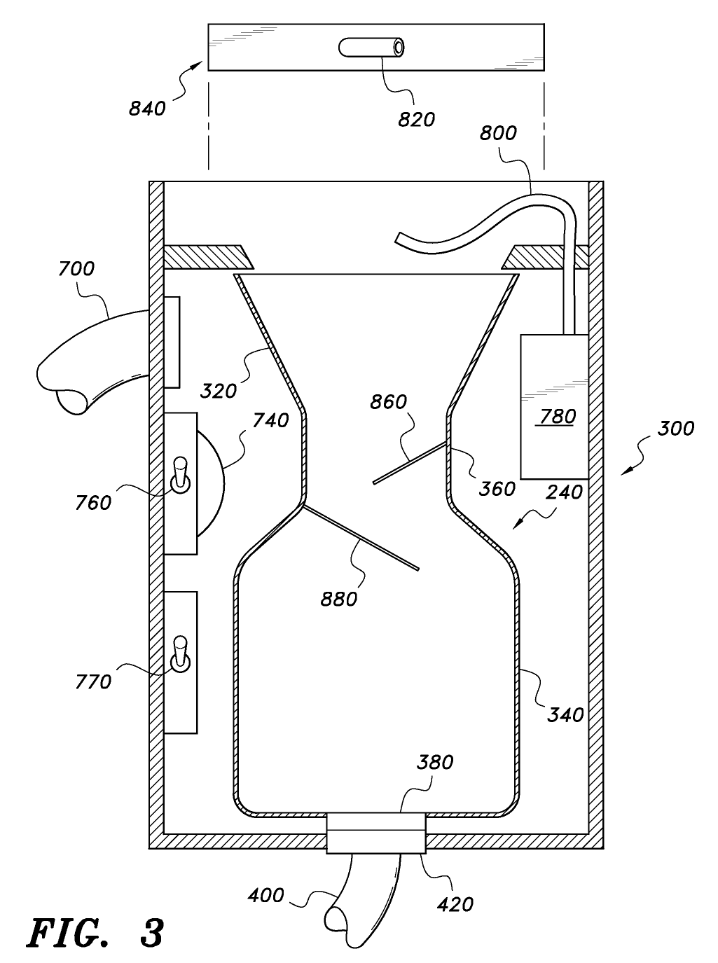

FIG. 3 shows details of the collection cup 240, it being understood that the collection cup 140 may have similar construction. The collection cup 240 is shown contained within a collection cup compartment 300 which may be formed as part of the cabinet 220. The collection cup 240 may be characterized as comprising a receiving funnel 320, a receptacle 340 for storing liquid wastes, and a relatively narrow neck 360 for conducting liquids from the receiving funnel 320 to the receptacle 340. A drain 380 may be formed in the receptacle 340.

The collection cup 240 may be hand held when collecting liquid wastes, then drained in the following way. The collection cup 240 may be returned to the collection cup compartment 300 in an emptying location shown in FIG. 3. In this location, the drain 380 may interact with a drain conduit 400 which leads to the holding tank 260 to dispose of liquid wastes. The drain conduit 400 may have a connector fitting 420 which cooperates with the drain 380 to assure closure of the collection cup 240 when the latter is disconnected from the connector fitting 420. The drain 380 may comprise a female valve normally urged into the closed position, and which is opened by the connector fitting 420, which is a male counterpart to the female valve. The female valve may be activated by merely pressing the collection cup 240 downwardly as seen in FIG. 3, or alternatively may be arranged to require that the collection cup 240 be rotated about its longitudinal axis as it is urged downwardly. The longitudinal axis is that axis extending through the funnel 320, the neck 360, and the receptacle 340. The connector fitting 420 may be held in the location shown in FIG. 3 by structure associated with the collection cup compartment 300. In summary, installation of the collection cup 240 to the drain 400, and more particularly to the connector fitting 420 of the drain 400, causes mating of and fluid communication between the drain 380 and the drain conduit 400.

Returning to FIG. 2, connection of the drain conduit 400 to the holding tank 260 is accomplished using quick connectors, shown representatively at 440. It is desirable to provide quick connectors to enable expeditious removal of the holding tank 260 for disposing of liquid wastes which have accumulated therein.

A vent conduit 460 also connects to the holding tank 260, and leads to a fan (not directly visible, being enclosed within a suitable housing 480). The vent conduit 460 is disposed to conduct vapors from said holding tank 260, the vent fan represented by the housing 480 being disposed to eject vapors from the vent conduit 460. The vent fan will be understood to be provided with operable electrical power, such as by incorporating a battery and operable circuitry (not shown). The vent conduit 460 may comprise a flexible hose, and may be fitted with a quick connector for connection to the holding tank 260, as with the quick connectors 440 of the drain conduit 400.

The wash water tank 280 is shown contained within a water tank compartment 500 beside the compartment 520 for containing the holding tank 260. The water tank compartment 500 is dimensioned and configured to receive the wash water tank 280 and its associated components. The wash water tank 280 may comprise a port 540, a pump 560 having a hose connection nipple 580, a wash water hose 600 which is matingly compatible with the port 540 and with the hose connection nipple 580, a battery 620, and circuitry disposed to conduct power from the battery 620 to the pump 560. The circuitry, which may include a switch (not shown), is well within the ability of one of ordinary skill in the art to arrange, and hence is not set forth herein in detail.

The wash water tank 280 may have a handle 640 formed integrally therewith, and a removable flexible wash water conduit or hose 660. The port 540 will be understood to comprise a quick connector fitting which is matingly compatible with a corresponding quick connector fitting formed as a terminal of the hose 660. Quick connectors for hoses are known in the field of pneumatic equipment and need not be further detailed herein. The quick connectors are shown representatively at 680. The wash water tank 280 may have a fill port 685 and a manually removable closure 690.

The holding tank 260 may also have an integral handle 695.

The collection cup compartment 300 may comprise its own vent conduit 700, which is disposed to conduct vapors from the collection cup compartment 300 into the vent conduit 460 or alternatively, to exhaust vapors independently of the vent conduit 460.

The cabinet 220 may be sufficiently large as to accommodate a mattress or bed 720 above the water tank compartment 500 and the holding tank compartment 520. The conduit 700 may conveniently be routed below the structure of the cabinet 220 which supports the bed 720.

Referring again to FIG. 3, the upper terminus of the vent conduit 700 is seen to be located at a wall of the collection cup compartment 300. Also provided within the collection cup compartment 300 may be a light 740 disposed to project light into the collection cup compartment, having a switch 760, and a rinse arrangement for rinsing the collection cup 240. A second switch 770, which may comprise a limit switch arranged to operate the vent fan 480 (see FIG. 2) when a door 900 (described hereinafter) of the collection cup compartment 300 is open.

The rinse arrangement may comprise a pump 780 which may be manual or electric, and which may incorporate a liquid reservoir (not shown). The pump 780 may be provided with a rinse water conduit or short hose 800 which extends to just above the collection cup 240. There, the short hose 800 may engage a connection nipple 820 formed in a cap 840 which may be available to close the collection cup 240 at the upper end of the latter. The short hose 800 may be slipped over the connection nipple 820 or may be matingly compatible therewith in any other suitable way. The same holds true for connection with the pump 780. The cap 840 is shown spaced above the collection cup 240 for clarity of the view in FIG. 3.

A further feature of the collection cup 240 is a baffle arrangement for suppressing splatter which otherwise could eject liquid wastes from the collection cup 240. Two inclined baffles 860, 880 are arranged to oppose egress of liquids contained within the receptacle 340 by denying direct access to the funnel 320. Inclination of the baffles 860, 880 promotes flow of liquids into the receptacle 340 when the collection cup 240 is held upright, as depicted in FIG. 3.

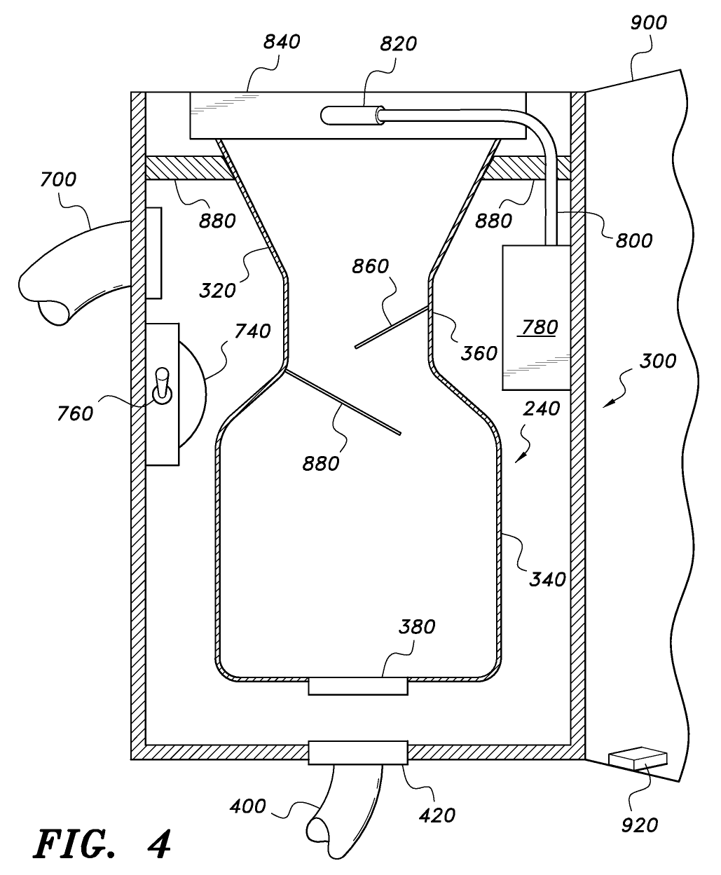

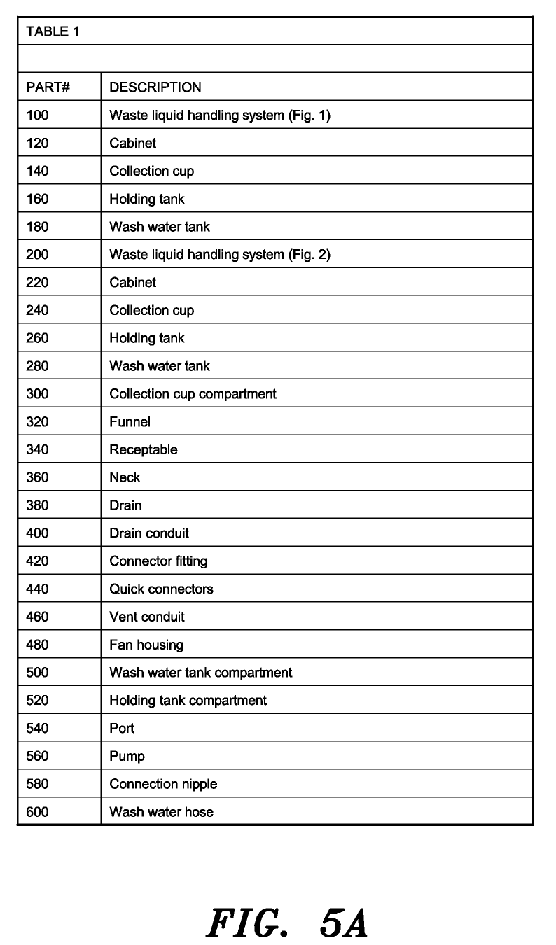

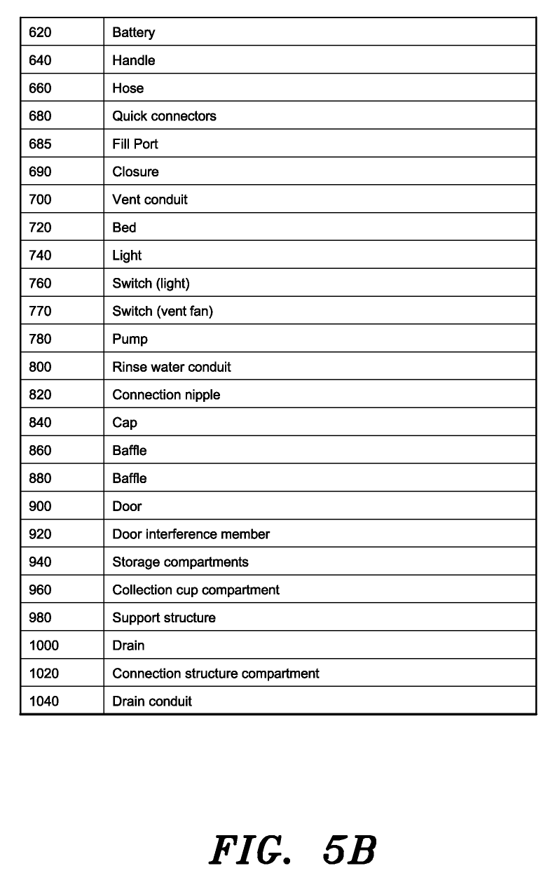

It will be seen that the collection cup 240 may be fitted just below support structure 880 which is used to hold the collection cup in a stowed location which is shown in FIG. 4. The support structure 980 may also serve as support structure to hold the short hose 800 in place. Alternatively, a clip (not shown) may be fastened to a wall of the collection cup compartment 300 to secure the short hose 800 in place.

Turning to FIG. 4, the collection cup 240 is seen to be held in a stowed position by the support structure 880. More specifically, the support structure 880 may have an inclined surface which cooperates with the inclined walls of the funnel 320. In the stowed position, the receptacle 340 and its associated drain 380 are spaced apart from the connector fitting 420. Because of the integral valve, which is closed when not contacting the connector fitting 420, the drain 380 does not discharge liquid contents from the receptacle 340 until returned to the engaged position shown in FIG. 3.

The collection cup compartment 300 may comprise a laterally facing side which is selectively opened and closed by a door 900.

The laterally facing side in FIG. 4 is that which reveals the collection cup. The door 900 is shown hinged at the right, and swung open. The door 900 may include a door interference member 920 disposed to prevent the door 900 from closing when the collection cup 240 is in the emptying position shown in FIG. 3. In the stowed position of FIG. 4, a gap exists below the collection cup 240, so that the door interference member 920 can pass therethrough, thereby enabling the door 900 to close. The door interference member 920 is located sufficiently high on the door 900 so that the former would contact and be obstructed by the collection cup 240 when the collection cup 240 is in the emptying position of FIG. 3.

The cap 840 is shown installed on the collection cup 240 in FIG. 4, with the short hose 800 installed on the connection nipple 820. The cap 840 may incorporate a flush manifold which is disposed to wash the funnel 320 when the removable cap 240 is installed on the funnel 320 and a water source is connected to the cap 840. The pump 780 may serve in the capacity of a water source.

Returning to FIG. 1, the waste liquid handling system 100 may have storage compartments 940. In addition, the waste liquid handling system 100 may be provided with any of the amenities of the waste liquid handling system 200, where feasible.

Due to more limited space than is provided in the relatively larger cabinet 220, a collection cup compartment 960 may lack connection structure for connecting the collection cup 140 as has been described with respect to the collection cup 240. Instead, connection structure 980 may be provided which is different from that of the collection cup compartment 300 in that it is adapted to receive connection of the collection cup 140 from the side, rather than from the top. To this end, the collection cup 140 may have a drain 1000 adapted to project laterally. Both the connection structure 980 and the drain 1000 may have quick connectors and in the case of the drain 1000, an integrated valve for closing the collection cup 140, in the manner of the collection cup 240. The connection structure 980 may be contained within its own compartment 1020, and of course communicates with a drain conduit 1040 for conducting liquid wastes to the holding tank 160.

I claim:

1. A waste liquid handling system especially adapted for retrofit installation within a transportation vehicle, comprising:
a collection cup having a receptacle for storing liquid wastes, a receiving funnel, a relatively narrow neck for conducting liquids from said receiving funnel to said receptacle, and a drain formed in said receptacle;
a holding tank for receiving liquid wastes from said collection cup;
a drain conduit disposed to conduct liquid wastes from said drain to said holding tank, having a proximal end for engaging said drain, and a distal end for connection to said holding tank;
a valve disposed to close said drain conduit when said drain is not connected to said collection cup;
a cabinet having a collection cup compartment having first support structure disposed to receive said collection cup in an emptying location and to hold said proximal end of said drain conduit in a location such that installation of said collection cup to said drain conduit causes mating of and fluid communication between said drain and said drain conduit.

2. The waste liquid handling system according to claim 1, wherein said cabinet comprises second support structure disposed to hold said collection cup in a stowed location wherein said collection cup is contained within said collection cup compartment, and said valve is closed.

3. The waste liquid handling system according to claim 1, wherein said collection cup compartment comprises a laterally facing side, a door for selectively opening and closing said laterally facing side, and a door interference member disposed to prevent said door from closing when said collection cup is in said emptying location.

4. The waste liquid handling system according to claim 1, further comprising a wash water tank having a port, a pump having a hose connection nipple, a wash water hose which is matingly compatible with said port and said hose connection nipple, a battery, and circuitry disposed to conduct power from said battery to said pump.

5. The waste liquid handling system according to claim 4, wherein said cabinet has a wash water tank compartment which is dimensioned and configured to receive said wash water tank, said pump, and said battery.

6. The waste liquid handling system according to claim 5, wherein said cabinet further comprises a holding tank compartment and a bed located above said wash water tank compartment and said holding tank compartment.

7. The waste liquid handling system according to claim 1, wherein said wash water tank has a handle formed integrally therewith, a quick connector fitting for mating with a hose, and a removable flexible hose having a terminal which is matingly compatible with said quick connector fitting of said wash water tank.

8. The waste liquid handling system according to claim 1, wherein said collection cup further comprises a removable cap incorporating a flush manifold disposed to wash said funnel when said removable cap is installed on said funnel and a water source is connected to said removable cap.

9. The waste liquid handling system according to claim 8, wherein said removable cap comprises a connector for connecting the water source thereto, further comprising a rinse water conduit which is matingly compatible with said pump and with said connector of said removable cap.

10. The waste liquid handling system according to claim 8, wherein said collection cup comprises at least one baffle disposed within said neck, wherein said baffle is disposed to oppose egress of splatter from said receptacle of said collection cup.

11. The waste liquid handling system according to claim 8, further comprising a vent conduit disposed to conduct vapors from said holding tank, and a vent fan disposed to eject vapors from said vent conduit.

12. The waste liquid handling system according to claim 8, further comprising a vent conduit disposed to conduct vapors from said collection cup compartment, and a vent fan disposed to eject vapors from said vent conduit.

13. The waste liquid handling system according to claim 12, wherein said collection cup compartment comprises a door and a limit switch arranged to operate said vent fan when said door of said collection cup compartment is open.

14. The waste liquid handling system according to claim 1, further comprising a light disposed to project light into said collection cup compartment, and a switch disposed to control said light.

15. The waste liquid handling system according to claim 1, wherein said collection cup has a longitudinal axis extending through said funnel, said neck, and said receptacle, and installation of said collection cup to said supporting structure is accomplished by rotating said collection cup about said longitudinal axis.

16. The waste liquid handling system according to claim 1, wherein said holding tank has an integral handle, a quick connector for connecting said drain conduit thereto, and a quick connector for connecting said vent conduit thereto.
